(19) United States
(12) Patent Application Publication
(10) Pub. No.: US 2003/0142623 A1
(43) Pub. Date: Jul. 31, 2003

(54) Method for random access packet transmission by performing load control functionality

(76) Inventors: Urs Peter Bernhard, Nuremberg (DE); Qiang Cao, Swindon (GB); Jens Mueckenheim, Nuremberg (DE)

Correspondence Address: Docket Administrator (Room 3J-219), Lucent Technologies Inc., 101 Crawfords Corner Road, Holmdel, NJ, 07733-3030, US

(21) Appl. No.: 10/351,831

(22) Filed: Jan. 27, 2003

(30) Foreign Application Priority Data
Jan. 28, 2002 (EP) 02250557.2

(51) Int. Cl. H04J 1/16; H04J 3/14

(52) U.S. Cl. 370/229; 370/338; 370/349

(57) ABSTRACT

A new and improved approach is described to avoid problems of overload handling for a random access packet transmission in packet switched mobile networks and in particular, to limit the transmit delay of at least some selected data flows even in case of a long-term overload situation. It is suggested to employ on a respective random access packet transmission channel an admission control functionality depending on a request for the adding of a new data flow and/or to employ on the respective random access packet transmission channel a congestion control functionality depending on varying environments.

### CROSS REFERENCE TO RELATED APPLICATION

This application claims priority of European Application No. 02250557.2, filed on Jan. 28, 2002.

### FIELD OF THE INVENTION

The invention relates to a method of random access packet transmission in a packet switched mobile network, and to an apparatus for a packet switched mobile network having such functionality.

### BACKGROUND OF THE INVENTION

In general, the invention addresses the problem of efficient packet transmitting of data flows in packet switched mobile networks for a transfer of data between a mobile station, also termed user equipment (UE) and a local base transceiver station (BTS) in downlink, i.e. in direction to the mobile station, and/or in uplink, i.e. in direction to the base transceiver station.

As is known, packet transmission is a key feature for communication systems of the third Generation such as UMTS, as defined by the 3GPP standard. Methods for improving the packet transmission and its efficiency have been deployed on both the downlink and uplink. On the downlink the radio access network usually has a complete knowledge of how much, when and to whom, the packet transmission are made.

For the uplink packet transmission, however, where all user equipments or mobile stations are uncoordinated, a fully centralized controlled method, such as for example a scheduling based method, is not feasible.

However, a procedure is set forth in the MAC (medium access control) protocol specification for UMTS for gaining transmission access by making random packet transmission on a random access channel (RACH) and detecting, according to a collision detect multiple access process, whether the packet transmission is received and acknowledged by the receiver. If the transmission is unsuccessful, the transmitter tries the transmission again after a random time interval. The time interval is lengthened according to a persistency value, which is derived by the radio access network based on the served traffic volume. Consequently the uplink packet transmission can be controlled through persistency value broadcast on the downlink.

The principle of such persistency control is that the radio access network monitors the uplink traffic load and broadcasts a persistency value, such as, for example, the transmission probability, on the broadcast control channel (BCH). Based on the broadcast persistency information, the user equipments decide their own transmission probability or re-transmission probability, so that the packet access in the uplink, such as, for example, on the random access channel (RACH) and common packet channel (CPCH), can be controlled.

However, especially in CDMA (Code Division Multiple Access) based packet switched mobile communication systems like a universal mobile telecommunication system (UMTS) as defined by the 3GPP standard, there exist mainly two reasons for a system overload which additionally may result, in particular in case of a long-term system overload, in problems of the packet transmission functionality.

Firstly, such a mobile communication system may become overloaded when a new user equipment has to be added and there are less free resources available then requested.

Secondly, the mobile communication system with existing data flows may become overloaded with regard to Quality of Service (QoS) metrics when the QoS compliant load offered by each existing data flow is larger than the average served load. In wire-line networks, this potential problem is typically bounded by the variation of the offered load and can be tackled by computing each data flow's activity with the contracted minimum QoS rate guarantees. In wireless networks, however, the environmental conditions are usually changing, such as, for example, due to the mobility of the mobile stations. This in turn directly impacts, in particular in CDMA based systems, the airlink resource consumption and thus the entire system capacity. Since the mobility of the user equipments is hardly predictable, any load balancing mechanism is crucial.

Thus, even if a given random access transmission system using a persistency control approach is adapted to keep the system stable in the case of an overload by decreasing the transmit probability, based for example on a high random access channel load, a significantly increased transmit delay may be caused thereby.

As a consequence, on one hand, such a transmit delay might not be critical in case of a short-term overload, since a random access channel, such as, for example, the CPCH, only serves data flows with a relaxed delay requirement, such as for example a TCP/IP (transmission control protocol/ internet protocol) transmission.

On the other hand, however, in case of a long-term overload, this can cause an undesirable behavior when the delay is growing beyond a certain level. Then, for example, a TCP congestion control usually starts a retransmission of the whole TCP packet, which may lead to a substantial waste of air interface resources. The length of such a long-term period for entering the state of overload depends heavily on the system or network and the supported services.

Thus, up to now random access transmission procedures of packet switched mobile networks are only able to handle problems of potential short-term overload situations.

It is an object of the present invention to provide a new and improved approach to avoid problems of overload handling for a random access packet transmission in packet switched mobile networks, as described above, and, in particular, to limit the transmit delay of at least some selected data flows even in case of a long-term overload situation.

### SUMMARY OF THE INVENTION

According to the invention for performing random access packet transmission, it is suggested to employ an admission control functionality on a respective random access packet transmission channel depending on a request for the adding of a new data flow, and/or to employ a congestion control functionality on the respective random access packet transmission channel depending on varying environments, in particular, based on the mobility of a mobile station served by the network for maintaining quality of service requirements and/or guarantees even in long-term overload situations of a packet switched mobile network, especially in a CDMA based network.

Accordingly, the such enhanced random access functionality is able to tackle problems caused in particular by long-term overload situations that can not be handled by known random access approaches.

In particular, by using the inventive admission control functionality depending on the request for adding a new data flow, a communication system having such enhanced random access control functionality for a mobile network can preserve a certain degree of quality of service (QoS), in particular, in terms of limiting the transmission delay, for the active or ongoing data flows that are handled by the random access packet transmission processing system even in the case when a new data flow has to be added to the system.

Moreover, by the use of the inventive congestion control functionality the communication system having such enhanced random access control functionality can preserve a certain degree of quality of service for the active or ongoing data flows that are handled by the random access packet transmission processing system even if the environmental conditions are changing, in particular, based on the mobility of the mobile stations forming a specific problem of mobile communication networks such as UMTS.

Advantageously, the inventive method is adapted in that the control decisions are performed by using the random access channel load, since it can be obtained in several ways. Preferably, the actual random access channel load is estimated by regularly comparing a measured receiving power from user equipments on the random access transmission channel with a measured total receiving power from all user equipments of a cell, and/or by counting the number of actually ongoing packet transmissions within a certain time interval.

According to a further preferred refinement of the invention, it is proposed to regularly perform a persistency control functionality in that the actual persistency value is increased or decreased for allocation to the respective random access packet transmission channel within defined upper and lower limits in dependence on a comparison of an actually estimated random access channel load against a defined upper random access channel load limit, and/or that the actual persistency value is determined in dependence on the number of actually ongoing packet transmissions and the number of allowable new packets within a succeeding time interval on the respective random access packet transmission channel. Practically, by means of such persistency control functionality, the invention additionally ensures that short-term overload situations are solved, in particular, by allocating the persistency value for the actives data flows, that are handled by the inventive random access packet transmission approach depending on the current network load situation.

For enabling a very easy but effective admission control functionality, it is further proposed to compare, in case of a request for adding a new data flow, an actual persistency value, indicating the system loading, against an overload threshold to avoid an overload situation.

Preferably, the congestion control functionality is supervising the maintaining of the actual QoS requirements depending on the allocated persistency value for the comparison against an overload threshold during definable time frames for detecting an overload situation.

In particular, in case of performing the admission control functionality in combination with the congestion control functionality, according to the preferred refinement, the overload threshold comprises a safety factor for allowing a certain degree of reserve for the random access control functionality in order to avoid a “ping-pong” behavior.

Moreover, the invention proposes, according to a further advantageous refinement, in case of detecting an overload condition, the reduction of the offered traffic on the respective random access packet transmission channel, in particular by removing at least one ongoing data flow and/or by rejecting the new data flow and/or by replacing at least one ongoing data flow by the new data flow, depending on a respective detected overload condition and/or quality of service guarantees.

According to a further improved enhancement, in particular in case of the allocation of a user equipment to more than one random access channel, it is suggested to perform admission control functionality and/or congestion control functionality on a plurality of random access packet transmission channels by comparing a set of actually estimated random access channel load based values, respectively allocated to one of the random access packet transmission channels, against an overload threshold or an overload threshold including a safety factor for detecting an overload situation or condition.

Consequently, the main application of the inventive approach is a MAC (medium access control) level packet transmission system using a random access method, whereby the invention is especially suited for communication systems where the random access transmission probability is controlled by broadcasting a persistency value. As a further advantage however, the invention is not limited to such systems but can also be used in general packet transmission systems for efficient overload handling on MAC level.

### BRIEF DESCRIPTION OF THE DRAWING

FIG. 1 schematically depicts a flow chart indicating a preferred admission control functionality according to the invention;

FIG. 2 schematically depicts a flow chart indicating a preferred congestion control functionality according to the invention;

FIG. 3 schematically depicts a flow chart indicating a preferred persistency control functionality according to the invention.

### DETAILED DESCRIPTION

The invention is exemplary described based on a preferred application, in particular, implemented in the CDMA packet switched mobile communication UMTS system having random access packet transmission procedures as specified by the current 3GPP standards and designed for the Common Packet Channel (CPCH).

Based on such exemplar application and as an assumption for the following description, it is noted that the random access transmission generally is controlled by a persistency value called P_{Pers}. This persistency value usually is broadcast on the broadcast channel, i.e. on the BCH.

Furthermore, a load “load” is defined on the CPCH, wherein the load “load” is the fraction of the received power P_{CPCH} from all user equipments (UE) on the CPCH at the BTS which is called NodeB in UMTS, to the total received wideband power Pₜₒₜₐₗ from all user equipments of the respective associated cell at the BTS or NodeB.

Thus the load “load” can be expressed as

$$load = \frac{{P}_{CPCH}}{{P}_{total}} . \qquad equation 1$$

For limiting the interference from the user equipments on the CPCH to the user equipments on other channels of that cell, for example on a circuit switched dedicated channel (DCH), the power P_{CPCH} on the CPCH and hence, the load “load” can be limited.

Furthermore, it is noted that the load “load” is directly proportional to the transmit probability Pₜᵣₐₙₛₘᵢₜ due to:

load ∝N_{CPCH}* Pₜᵣₐₙₛₘᵢₜ. equation 2

In equation 2, the parameter N_{CPCH} denotes the number of user equipments which are allocated to the CPCH. In general, this number is known. The transmit probability Pₜᵣₐₙₛₘᵢₜ can be determined by the persistency value, preferably using the following relation that is specified in the current 3GPP UMTS standards.

Pₜᵣₐₙₛₘᵢₜ=2−(P_{Pers}−1). equation 3

Currently, the range of the persistency value is defined by:

1≦P_{Pers}≦8. equation 4

As a first consequence, the load “load”, based on equations 2 and 3, is inversely related to the persistency value P_{Pers}, and thus:

load ∝1/P_{Pers}, equation 5

and hence, the load “load” can be controlled by properly adjusting the persistency value Pₚₑᵣₛ.

It is, however, a further consequence that a caused delay of a packet transmission will be a decreasing function of the transmit probability Pₜᵣₐₙₛₘᵢₜ. In particular, in slotted systems the transmit delay is geometrical distributed, such as, for the example of the random access transmission system, where a transmission can only start at pre-defined times. Thus, a mean delay “delay” is inversely proportional to the transmit probability Pₜᵣₐₙₛₘᵢₜ and thus:

delay ∝1/Pₜᵣₐₙₛₘᵢₜ. equation 6

Consequently, based on equations 3 and 6 it should be obvious to a person skilled in the art, that the packet transmission delay “delay” is an increasing function of the persistency value P_{Pers} and hence, the parameter “delay” can be seen substantially as being proportional to P_{Pers}.

Accordingly, the higher the persistency value P_{Pers}, the longer is the packet transmission delay “delay”. As a result, there is a trade-off between the load “load” and the packet transmission delay “delay” when assigning the persistency value P_{Pers}, which has to be regarded by the inventive embodiment of employing a specific load controlling approach for the CPCH random access packet transmission functionality.

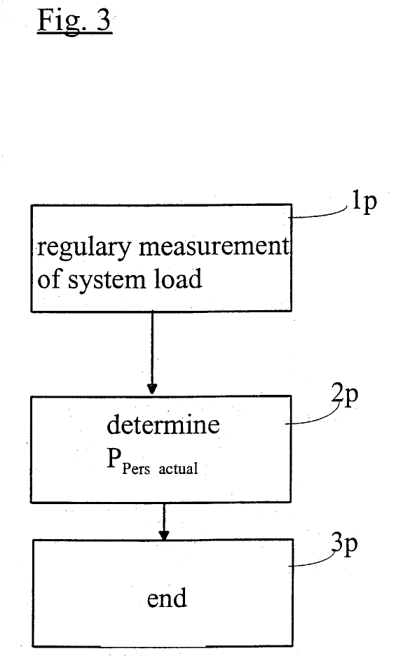

With reference first to FIG. 3, the principle of a persistency control functionality, preferably integrated within the inventive way of enhanced random access packet transmission, is schematically depicted.

The preferred persistency control functionality, as depicted, should be as follows.

The persistency control procedure is adapted in that during the operation of the transmission network and according to FIG. 3 step 1p, the radio access network regularly checks or estimates the random access channel load “load”. The persistency control functionality is triggered, when a new estimate of the random access channel load “load” is achieved.

One of the most practical ways of checking or estimating the random access channel load “load” comprises measuring the received powers P_{CPCH} and Pₜₒₜₐₗ and the use of equation 1 for estimating of the load “load”.

However, a further possibility for the estimation of a load indicating value is based on the counting of the number of access attempts N_{current} on the CPCH within a certain time interval, for example:

$$load = \frac{{N}_{current}}{{N}_{max}} , \qquad equation 7$$

wherein Nₘₐₓ represents the maximum allowed number of access attempts on the CPCH.

In general, the time period of the regular measurements concerning the load is denoted for the following description as the persistency control interval.

Based on the regular measurements, a preferred actual persistency value P_{Pers}_{^{—}}_{actual} is determined using the estimated random access channel load “load”, as indicated in FIG. 3 by reference sign 2p.

Furthermore, a preferred basic procedure therefore, is to use a comparison of the estimated load “load” against a given or definable maximal load threshold loadₘₐₓ, such as for example:

load≦loadₘₐₓ. equation 8

If equation 8 is not met, then an increment of the actual persistency value P_{Pers}_{^{—}}_{actual} by one is performed. However, according to equation 4, in the current 3GPP UMTS standards the persistency value P_{Pers} is set between 1 and 8. Thus a maximal or upper limit persistency value threshold is properly defined as being P_{Pers}_{^{—}}ₘₐₓ=8. Thus, when performing the increment of the actual persistency value P_{Pers}_{^{—}}_{actual} by one, it has to be ensured that P_{Pers}_{^{—}}_{actual} does not exceed P_{Pers}_{^{—}}ₘₐₓ.

If, however, equation 8 is met as a result of the determination step 2p, then a decrement of the actual persistency value P_{Pers}_{^{—}}_{actual} by one is performed. However, since the persistency value P_{Pers} is set between 1 and 8, a minimal or lower limit persistency value threshold is preferably defined, properly as being P_{Pers}_{^{—}}_{low}=1. Thus, when performing the decrement of the actual persistency value P_{Pers}_{^{—}}_{actual} by one, it has to be ensured that P_{Pers}_{^{—}}_{actual} is not lower than P_{Pers}_{^{—}}_{low}.

As a result, the persistency control procedure is finished for the moment as indicated by reference sign 3p of FIG. 3 and waits until a new random access channel load estimate is obtained. The determined and actualized persistency value P_{Pers}_{^{—}}_{actual} is however, signalled to the mobile user equipments, practically via the system broadcast channel BCH.

However, a further practical approach for determining a persistency value can be derived from the above mentioned number of access attempts N_{current}. For example, the allowed maximal uplink load threshold level is given as:

Pₜₒₜₐₗ_{^{—}}ₘₐₓ=function(loadₘₐₓ), equation 9

and hence is a system design parameter, which can be derived from the maximum cell load. Then, based on a homogeneous traffic pattern for circuit traffic, a current surplus power can be expressed as:

Pₜₒₜₐₗ_{^{—}}ₘₐₓ−Pₜₒₜₐₗ equation 10.

With the assumption, that all of the surplus power is consumed by newly arrived packet transmission, the number of new packets that can be allowed for the next transmission interval can be defined as:

$${N}_{next} = \frac{{P}_{total\_max} - {P}_{tatal}}{{P}_{CPCH}} \cdot {N}_{current} . \qquad equation 11$$

Since all user equipments will re-transmit in case of backlogged user equipments and/or transmit in case of new user equipments with the same transmit probability, a persistency transmission probability value Pₜᵣₐₙₛₘᵢₜ for a random access channel can be defined as:

$${P}_{transmit} = \frac{1}{{N}_{current} + {N}_{next}} \cdot {N}_{access} , . \qquad equation 12$$

wherein N_{access} is the number of available access slots and/or access codes on the CPCH. Then the actual persistency value P_{Pers}_{^{—}}_{actual} is derived from equation 3.

Subsequently, the principal of the inventive, in particular software implemented, approach of additionally employing a load controlled random access packet transmission concerning an admission control functionality and/or congestion control functionality is described.

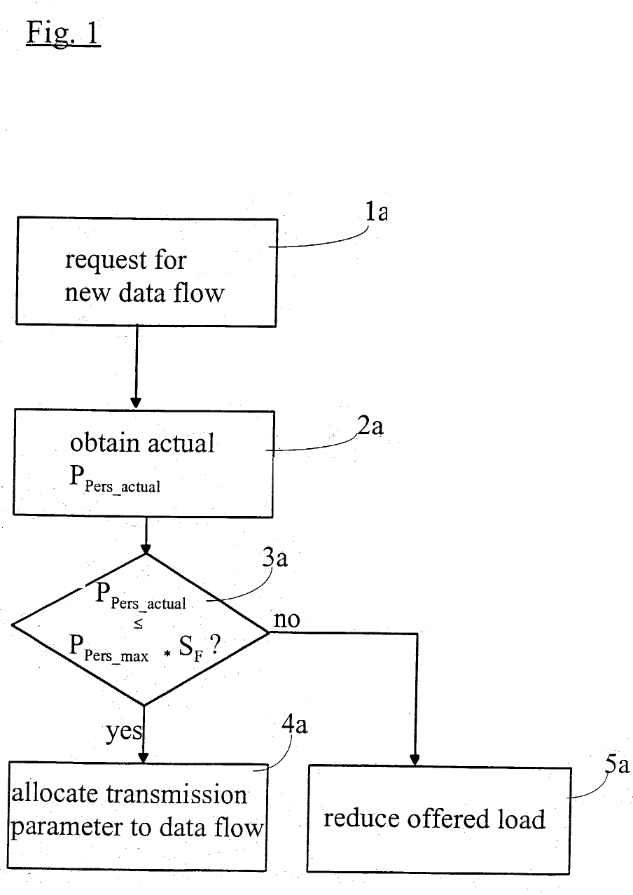

With reference to FIG. 1, the preferred, realization of the inventive admission control functionality within the random access packet transmission functionality, based on a request for the adding of a new data flow to be transmitted, employs the persistency value P_{Pers}_{^{—}}_{actual} and is as follows:

The admission control functionality is triggered in a first step 1a, when a request for adding a new data flow to the CPCH arrives. Then, in a second step 2a, the actual persistency value P_{Pers}_{^{—}}_{actual} allocated by the persistency control functionality within the respective last persistency control interval, as described above, is taken as a basis for the indication of the random access channel load and, hence, for performing the control functionality.

Subsequently, during a third step 3a, the means for performing such admission control functionality, practically embedded in a respective transceiver unit of a base transceiver station of the communication system, preferably is checking whether the adding of the new data flow would lead to an overload condition. A possible admission criterion according to the invention could be:

P_{Pers}_{^{—}}_{actual}≦P_{Pers}_{^{—}}ₘₐₓ·S_{F}/ equation 13

wherein P_{Pers}_{^{—}}ₘₐₓ is the maximal persistency value for the maximal allowable delay limit and S_{F} is a safety factor which preferably is set to S_{F}<1 to allow a certain degree of reserve for the random access control means in order to avoid any undesired “ping-pong” behavior when the admission control is combined with the inventive congestion control functionality, as described below.

If equation 13 is met, then the new requested data flow will not violate the allowable delay limits and, hence, can be admitted. As a consequence, it can proceed with step 4a, according to which the request for adding the new data flow has been admitted and the transmission parameters, such as, for example, the data rates, the transport formats, and spreading codes are allocated. The transmission parameters are then signalled, preferably together with a specific CPCH identification, to the mobile user equipment that has requested the data flow on the CPCH.

If, however, equation 13 is not met as a result of the checking step 3a, then in case of adding the new request the delay limits will be violated and, hence, the request can not be admitted. As a consequence it proceeds with step 5a of FIG. 1, trying to perform a reduction of the offered random access channel load for enabling the system to limit the actual delay, preferably including at least one of the two following actions:

Firstly, one approach for reducing the offered random access channel load is to simply reject the new request. This may be the preferred controlling functionality in the general case where all ongoing traffic should get priority over a new request.

Secondly, another possibility according to the invention is to remove one or more ongoing data flows from the CPCH in order to insert the new one. This may be the preferred option for handling calls with priority, such as, for example, emergency calls, where resources shall be pre-empted in order to proceed with the priority call.

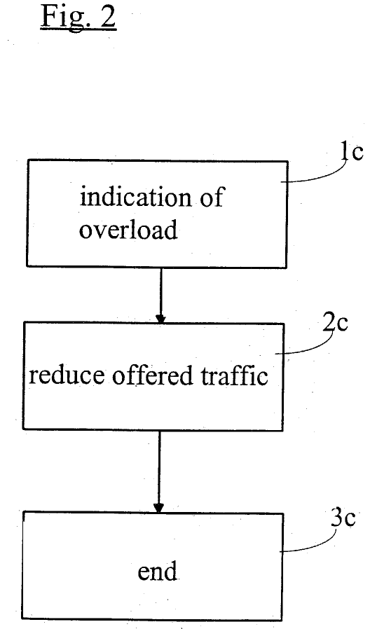

With reference to FIG. 2, the principle of the inventive random access packet transmission approach of employing congestion control functionality is schematically depicted. A preferred control functionality based on the exemplar CPCH of a UMTS based transmission system is proposed to be as follows.

During the operation of the transmission network, the congestion control procedure according to FIG. 2 is triggered in a first step 1c when the random access control means indicates an overload situation on the CPCH, for example by use of the persistency control functionality, as described above in connection with FIG. 3.

Thus, for indicating any overload situation the random access packet transmission functionality preferably is adapted to regularly check the allocated persistency value P_{Pers}.

Normally, the time frame for performing this check will be much larger than the persistency control interval because the CPCH usually is only in an overload situation if it can not serve the “long-term” delay requirements of the data flows. Short term fluctuations can be autonomously handled by the persistency control functionality, as described above. If the control means, however, is not able to serve all data flows during a longer time with the maximal allowable delay, the control means indicates the overload situation.

For indicating such an overload situation, preferably by use of the persistency value P_{Pers} in general, it is proposed to use the actual obtained persistency value P_{Pers}_{^{—}}_{actual} for defining an overload criterion as follows:

P_{Pers}_{^{—}}_{actual}≧P_{Pers}_{^{—}}ₘₐₓ. equation 14

As in the admission control functionality, the P_{Pers}_{^{—}}ₘₐₓ is the maximal persistency value, which is, for example, given by the maximal allowable delay limit. If equation 14 is valid over a longer time-scale, the persistency control indicates the overload situation. The length of this time-duration for entering the state of overload depends heavily on the system and the services in the respective system and, hence, must be set according to actual requirements.

As a result, the congestion control procedure is finished for the moment, as indicated by reference sign 3c of FIG. 2, and is waiting until a new overload situation is indicated by the scheduling functionality.

However, for overcoming an indicated overload situation, i.e. the given delay limits are not complied with anymore, the offered traffic must be reduced, as indicated by reference sign 2c. One preferred approach, therefore, is to remove one or several data flows from the CPCH, preferably in dependence on a priority scheme or order, such as, for example, to drop the data flows having the lowest priority at first, in order to reduce the random access channel load and hence to decrease the actual persistency value P_{Pers}_{^{—}}_{actual}. Another preferred approach is to first drop the data flows that are associated with the maximum transmit power for reducing the interference in the system.

Based thereon, it is necessary to remove so many data flows that the persistency value P_{Pers}_{^{—}}_{actual} is reduced below a definable congestion control based persistency value P_{Pers}_{^{—}}_{ConC} prior to proceeding further with step 3c, i.e. to finish the congestion control procedure for the moment and to wait until a new overload situation is indicated by the control means. However, a user equipment, which is removed from the CPCH is informed via dedicated signalling channels.

By combining the congestion control functionality with the admission control functionality, an overload situation according to step 1c of FIG. 2 even can be indicated in case of a transition from step 3a of FIG. 1 to step 5a due to a request for adding a new data flow.

Thus, it is obvious to a person skilled in the art that in case of combining both load control functionality's, the safety factor S_{F} used in equation 13 during step 3a of FIG. 1 should be less than 1 to avoid the afore-mentioned “ping-pong” behavior. Otherwise, if S_{F} is set to 1, the incorporation of a requested new data flow into the random access process, in particular by an actual need of the entire maximum persistency value P_{Pers}_{^{—max}} according to equation 13, may result in the detection of an overload situation by the congestion control functionality during a succeeding step.

In the exemplar inventive approach as described above only one CPCH has formed the basis for the inventive control functionality. However, according to the current 3GPP UMTS standards and/or specifications, even the allocation of at least one certain mobile user equipment to more than one CPCH, i.e. to a CPCH set, is allowed. The respective user equipment then chooses the CPCH for the transmission out of the allocated CPCH set according to a defined or definable allocation rule.

In this case, one preferred approach is to allocate a certain number of CPCH serving equal data rate. Based thereon, on each CPCH out of the CPCH set, an autonomous persistency control function may be applied according to the above description relating to FIG. 3. Then, it may be beneficial for the user equipment to use the inventive random access attempt on that CPCH where the lowest persistency value P_{Pers}_{^{—}}_{actual} has been allocated, since this CPCH is likely lowest loaded for balancing the traffic between the specific CPCH within the CPCH set.

As a consequence, in such a case, the admission control functionality, as described above in connection with FIG. 1, is proposed to be further enhanced in that not only the persistency value P_{Pers}_{^{—}}_{actual} on one CPCH has to be obtained but additionally the persistency values on the other CPCHs of the CPCH set.

With the assumption, that the total number of CPCHs of a CPCH set is k, the respective persistency value of a CPCH#i is P_{Pers}_{^{—}}_{actual} (i) and each CPCH#i has a maximal persistency value P_{Pers}_{^{—}}ₘₐₓ (i) wherein each of the maximal persistency values P_{Pers}_{^{—}}ₘₐₓ (i) can be the same, i.e. P_{Pers}_{^{—}}ₘₐₓ (i)=P_{Pers}_{^{—}}ₘₐₓ, the criterion in equation 13 preferably is adapted to:

P_{Pers}_{^{—}}_{actual}(i)≦P_{Pers}_{^{—}}ₘₐₓ(i)·S_{F}. equation 15

This means that the admission criterion is fulfilled for a CPCH#i when equation 15 is met for the respective i≦k.

Furthermore, regarding the inventive congestion control functionality, the overload check, as described above in connection with FIG. 2, can be performed for all CPCHs within a CPCH set at once and, hence, the congestion control functionality can be adapted similar to the enhanced approach relating to the admission control functionality.

Consequently, based on the afore-mentioned assumption, the congestion control criterion in equation 14 preferably is adapted to:

P_{Pers}_{^{—}}_{actual}(i)≧P_{Pers}_{^{—}}ₘₐₓ(i), equation 16

and means, that an overload situation is indicated for a CPCH#i when equation 16 is valid for the respective i≦k.

Moreover, even though the invention is exemplary described with regard to a random access transmission UMTS system on CPCH, it is obvious to a person skilled in the art, that substantially the same inventive functionality can be applied to control a packet transmission in general on transport channels, which are based on random access procedures for a known number of user equipments, such as for example for the DRAC (dynamic resource allocation control) procedure on uplink DCH (dedicated channel) as specified in the current 3GPP UMTS standards.

What is claimed:

1. A method of random access packet transmission for maintaining quality of service requirements and/or guarantees in a packet switched mobile network, comprising the step of:
performing on a respective random access packet transmission channel an admission control functionality depending on a request for the adding of a new data flow.

2. The method of claim 1, further comprising the step of:
performing on the respective random access packet transmission channel a congestion control functionality depending on varying environments.

3. The method of claim 1, further characterized by performing admission control functionality depending on an actually estimated random access channel load on the respective random access packet transmission channel.

4. The method of claim 1, wherein the step of performing admission control functionality comprises the steps of determining an actual persistency value for the comparison against an overload threshold or an overload threshold including a safety factor for detecting an overload condition.

5. The method of claim 2, wherein the step of performing congestion control functionality comprises the step of supervising the complying with the QoS requirements depending on an actual persistency value for the comparison against an overload threshold during definable time frames for detecting an overload condition.

6. The method of claim 1, further characterized by the step of regularly performing a persistency control functionality in that an actual persistency value for allocation to the respective random access packet transmission channel is increased or decreased within defined upper and lower limits in dependence on a comparison of an actually estimated random access channel load against a defined upper random access channel load limit and/or in that an actual persistency value for allocation to the respective random access packet transmission channel is obtained in dependence on the number of actually ongoing packet transmissions and the number of allowable new packets within a succeeding time interval on the respective random access packet transmission channel.

7. The method of claim 3, further characterized by estimating the actual random access channel load by comparing a measured receiving power from user equipments on the random access transmission channel with a measured total receiving power from all user equipments of a cell and/or by counting the number of actually ongoing packet transmissions within a certain time interval.

8. The method of claim 1, further comprising the steps of reducing the offered traffic on the respective random access packet transmission channel by removing at least one ongoing data flow and/or by rejecting the new data flow and/or by replacing at least one ongoing data flow by the new data flow, depending on a respective detected overload condition and/or quality of service guarantees.

9. The method of claim 1, further comprising the steps of performing admission control functionality on a plurality of random access packet transmission channels by comparing a set of actually estimated random access channel load based values, respectively allocated to one of the random access packet transmission channels against an overload threshold or an overload threshold including a safety factor for detecting an overload condition.

10. A method of random access packet transmission for maintaining quality of service requirements and/or guarantees in a packet switched mobile network, comprising the step of:
performing on a respective random access packet transmission channel a congestion control functionality depending on varying environments.

11. The method of claim 10, further comprising the step of:
performing on the respective random access packet transmission channel an admission control functionality depending on a request for the adding of a new data flow.

12. The method of claim 10, further characterized by performing congestion control functionality depending on an actually estimated random access channel load on the respective random access packet transmission channel.

13. The method of claim 11, wherein the step of performing admission control functionality comprises the steps of determining an actual persistency value for the comparison against an overload threshold or an overload threshold including a safety factor for detecting an overload condition.

14. The method of claim 10, wherein the step of performing congestion control functionality comprises the step of supervising the complying with the QoS requirements depending on an actual persistency value for the comparison against an overload threshold during definable time frames for detecting an overload condition.

15. The method of claim 10, further characterized by the step of regularly performing a persistency control functionality in that an actual persistency value for allocation to the respective random access packet transmission channel is increased or decreased within defined upper and lower limits in dependence on a comparison of an actually estimated random access channel load against a defined upper random access channel load limit and/or in that an actual persistency value for allocation to the respective random access packet transmission channel is obtained in dependence on the number of actually ongoing packet transmissions and the number of allowable new packets within a succeeding time interval on the respective random access packet transmission channel.

16. The method of claim 12, further characterized by estimating the actual random access channel load by comparing a measured receiving power from user equipments on the random access transmission channel with a measured total receiving power from all user equipments of a cell and/or by counting the number of actually ongoing packet transmissions within a certain time interval.

17. The method of claim 10, further comprising the steps of reducing the offered traffic on the respective random access packet transmission channel by removing at least one ongoing data flow and/or by rejecting the new data flow and/or by replacing at least one ongoing data flow by the new data flow, depending on a respective detected overload condition and/or quality of service guarantees.

18. The method of claim 10, further comprising the steps of performing congestion control functionality on a plurality of random access packet transmission channels by comparing a set of actually estimated random access channel load based values, respectively allocated to one of the random access packet transmission channels against an overload threshold or an overload threshold including a safety factor for detecting an overload condition.
